(19) United States
(12) Patent Application Publication
(10) Pub. No.: US 2026/0023971 A1
(43) Pub. Date: Jan. 22, 2026

(54) MULTI-GRAPH NEURAL NETWORK FRAMEWORK FOR GENERALIZED MULTIMODAL FUSION OF DATA FOR OUTCOME PREDICTION

(71) Applicant: International Business Machines Corporation, Armonk, NY (US)

(72) Inventors: Niharika DSouza, San Jose, CA (US); HONGZHI WANG, Santa Bruno, CA (US); Andrea Giovannini, Zurich (CH); Antonio Foncubierta Rodriguez, ZURICH (CH); Tanveer F. Syeda-Mahmood, Cupertino, CA (US)

(21) Appl. No.: 18/779,210

(22) Filed: Jul. 22, 2024

(51) Int. Cl. G06N 3/084

(52) U.S. Cl. CPC G06N 3/084

(57) ABSTRACT

One or more systems, devices, computer program products and/or computer-implemented methods of use provided herein relate to predicting an optimized result for a graph neural network (GNN). A system can comprise a memory configured to store computer executable components; and a processor configured to execute the computer executable components stored in the memory, wherein the computer executable components comprise: a fusion component that that models non-linear modality correlations within and across entities through Hirschfeld-Gebelein-Re'nyi maximal correlation (MaxCorr) embeddings that generates a multi-graph that preserves identities of modalities and entities; and a multi-graph neural network (MGNN) component for task-informed reasoning in multi-graphs, that learns parameters defining entity-modality graph connectivity and message passing in an end-to-end fashion.

### BACKGROUND

The subject disclosure relates to a multi-graph neural network framework for generalized multimodal fusion of data (e.g., medical data) for outcome prediction.

### SUMMARY

The following presents a summary to provide a basic understanding of one or more embodiments described herein. This summary is not intended to identify key or critical elements, delineate scope of embodiments or scope of claims. Its sole purpose is to present concepts in a simplified form as a prelude to the more detailed description that is presented later. In one or more embodiments described herein, systems, computer-implemented methods, apparatus and/or computer program products that enable prediction of future possibility of bias in an AI model are discussed.

According to an embodiment, a computer-implemented system is provided. The computer-implemented system can comprise a memory configured to store computer executable components; and a processor configured to execute the computer executable components stored in the memory, wherein the computer executable components comprise: a fusion component that that models non-linear modality correlations within and across entities through Hirschfeld-Gebelein-Re'nyi maximal correlation (MaxCorr) embeddings that generates a multi-graph that preserves identities of modalities and entities; and a multi-graph neural network (MGNN) component for task-informed reasoning in multi-graphs, that learns parameters defining entity-modality graph connectivity and message passing in an end-to-end fashion.

According to another embodiment, a computer-implemented method is provided utilizing a processor that executes computer executable components stored in memory to: model non-linear modality correlations within and across entities through Hirschfeld-Gebelein-Re'nyi maximal correlation (MaxCorr) embeddings that generates a multi-graph that preserves the identities of the modalities and entities; and utilizing a multi-graph neural network (MGNN) for task-informed reasoning in multi-graphs to learn parameters defining entity-modality graph connectivity and message passing in an end-to-end fashion.

According to yet another embodiment, a computer program product comprises a computer readable storage medium having program instructions embodied therewith, the program instructions executable by processor to cause the processor to: model non-linear modality correlations within and across entities through Hirschfeld-Gebelein-Re'nyi maximal correlation (MaxCorr) embeddings that generates a multi-graph that preserves the identities of the modalities and entities; and utilize a multi-graph neural network (MGNN) for task-informed reasoning in multi-graphs to learn parameters defining entity-modality graph connectivity and message passing in an end-to-end fashion.

### DESCRIPTION OF THE DRAWINGS

FIG. 1 illustrates challenges of multimodal fusion in machine learning, where data from different modalities (e.g., images, speech, text) are integrated.

FIG. 2 illustrates a block diagram of a non-limiting system that can predict outcomes in accordance with one or more embodiments described herein.

FIG. 3 depicts a Maximal Correlation (MaxCorr) Formulation for multimodal data fusion in accordance with one or more embodiments described herein.

FIG. 4 illustrates a multi-graph neural network for outcome prediction in accordance with one or more embodiments described herein.

FIG. 5 depicts a coupled objective function in accordance with one or more embodiments described herein.

FIG. 6 illustrates a training and evaluation process using a large tuberculosis (TB) dataset in accordance with one or more embodiments described herein.

FIGS. 7-9 illustrate outcome prediction performance of the subject framework against single modality predictors, state-of-the-art fusion frameworks, and ablated versions of an embodiment model in accordance with one or more embodiments described herein.

FIGS. 10-11 illustrate an example methodology in accordance with one or more embodiments described herein.

FIG. 12 illustrates a block diagram of an example, non-limiting, operating environment in which one or more embodiments described herein can be facilitated.

Appendix A, which forms part of this specification, is a copy of a paper entitled MaxCorrMGNN: A Multi-Graph Neural Network Framework for Generalized Multimodal Fusion of Medical Data for Outcome Prediction.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Graph Neural Networks (GNNs) are a class of neural network models designed to operate on graph-structured data. Graphs consist of nodes (vertices) connected by edges (links), and they are a versatile way to represent data with complex relationships and structures, such as social networks, recommendation systems, biology, knowledge graphs, and more. GNNs were developed to perform machine learning tasks on such graph-structured data. Some components used in a GNN are as follows. There are node features in a graph, in which each node on a graph has associated features or attributes specific to the node, like user profiles in a social network or chemical properties in a molecular graph. There is message passing which is often a significant operation of a GNN. GNNs iteratively update representation of nodes by aggregating information from neighbouring nodes. This allows nodes to consider features and relationships of connected nodes. GNNs also employ aggregation in which aggregated information is typically combined through a neural network layer (e.g., a weighted sum or a more complex operation), which may include both a node's own features and information from its neighbours. After aggregating information from neighbours, a new representation of the node is generated. This updated representation can be used for various downstream tasks, e.g., such as classification, regression, or clustering.

The term entity (and associated counterpart terms) is intended to include but is not limited to: an individual, a set of individuals, a device, hardware, software, a living organism, a set of living organisms or the like, or any combination of the above.

In GNNs, a same neural network architecture is used for respective nodes in a graph, and the parameters (weights) are shared across nodes. This is similar to how convolutional layers share weights in Convolutional Neural Networks (CNNs). GNNs can have multiple layers, allowing for propagation of information across a graph through multiple iterations of message passing. This enables GNNs to capture complex dependencies and relationships within the graph.

Common architectures and variations of GNNs include but are not limited to Graph Convolutional Networks (GCNs), GraphSAGE, Graph Isomorphism Networks (GIN), and GATs (Graph Attention Networks). GATs are designed to work with graph-structured data and are particularly well-suited for tasks that involve learning from relationships between nodes in a graph. GATs can have greater ability to effectively capture complex dependencies and variations in graph data. These models have been successfully applied to various tasks, such as node classification, link prediction, graph classification, and more. GNNs have become a significant tool for analysing and making predictions on graph-structured data in a wide range of applications e.g., such as detecting money laundering, financial fraud, credit risk analysis and more.

Graph Neural Networks (GNNs) can be employed to detect financial fraud by modeling and analyzing the complex relationships and interactions among financial entities, such as account holders, transactions, and other entities in a financial network. GNNs can function by using techniques as described below.

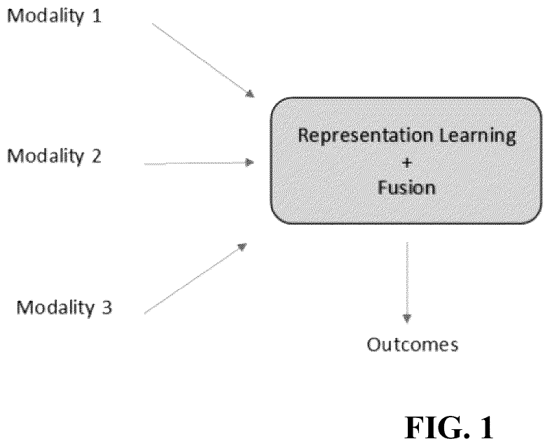

With the emergence of multimodal electronic health records, evidence for an outcome may be captured across multiple modalities ranging from clinical to imaging and genomic data. Predicting outcomes effectively requires fusion frameworks capable of modeling fine-grained and multi-faceted complex interactions between modality features within and across entities. FIG. 1 depicts challenges of multimodal fusion in machine learning, where data from different modalities (e.g., images, speech, text) are integrated. It highlights a problem of aligning and combining diverse multimodal features for prediction, aiming to solve tasks optimally with minimal computational effort. This issue is significant as evidence is often distributed across multiple modalities, and single modality data may be insufficient for robust conclusions. Innovations described herein involve representation learning and fusion to produce outcomes.

FIG. 1 illustrates challenges of multimodal fusion in machine learning, where data from different modalities (e.g., images, speech, text) are integrated. It highlights a problem of aligning and combining diverse multimodal features for prediction, aiming to solve tasks optimally with minimal computational effort. This issue is significant as evidence is often distributed across multiple modalities, and single modality data may be insufficient for robust conclusions. Processes disclosed herein involve representation learning and fusion to produce outcomes.

Developed is an innovative fusion approach called MaxCorr MGNN that models non-linear modality correlations within and across entities through Hirschfeld-Gebelein-Re'nyi maximal correlation (MaxCorr) embeddings, resulting in a multi-graph that preserves identities of modalities and entities. Designed, is a generalized multi-graph neural network (MGNN) for task-informed reasoning in multi-graphs, that learns parameters defining entity-modality graph connectivity and message passing in an end-to-end fashion. A non-limited example model with respect to an outcome prediction task on a Tuberculosis (TB) dataset consistently outperformed several state-of-the-art neural, graph-based and traditional fusion techniques. Multimodal Fusion Hirschfeld-Gebelein-Re'nyi (HGR) maximal correlation Multi-graphs Multi-Graph Neural Networks.

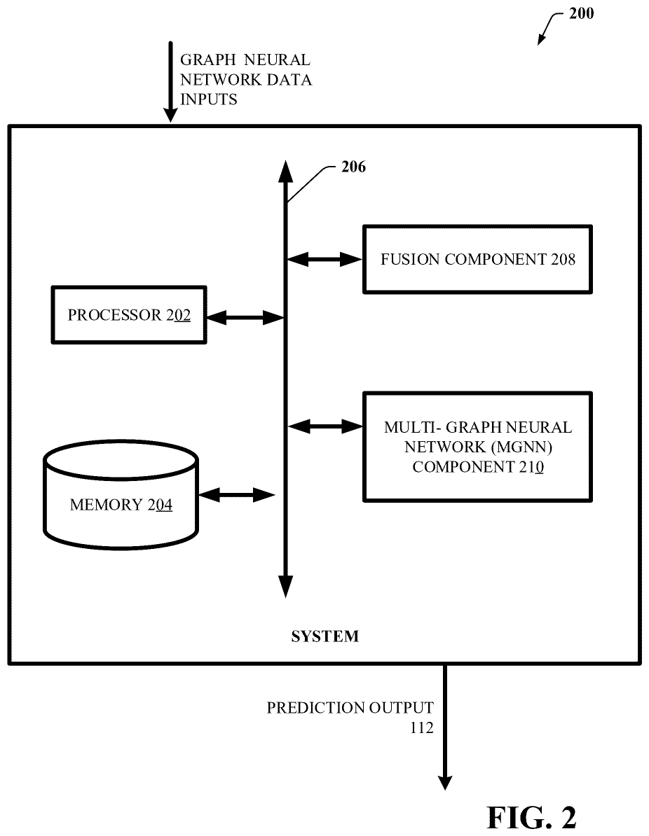

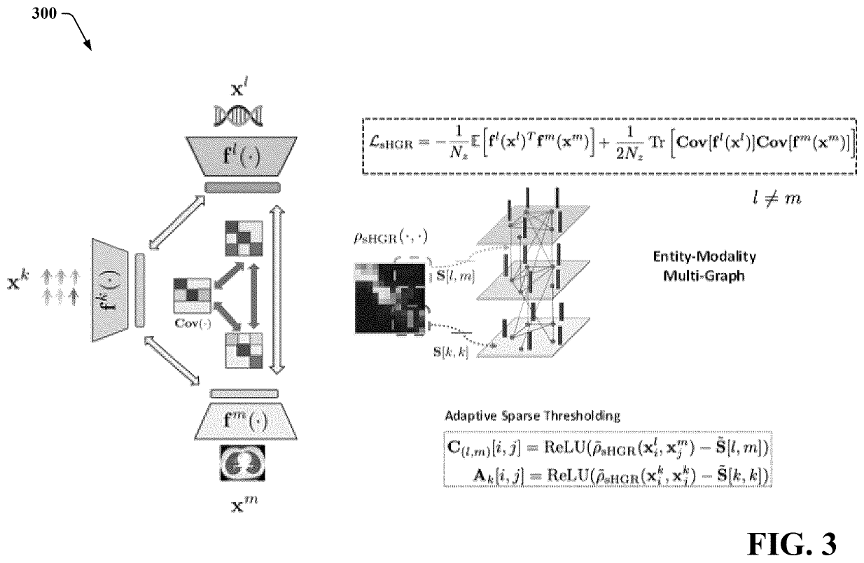

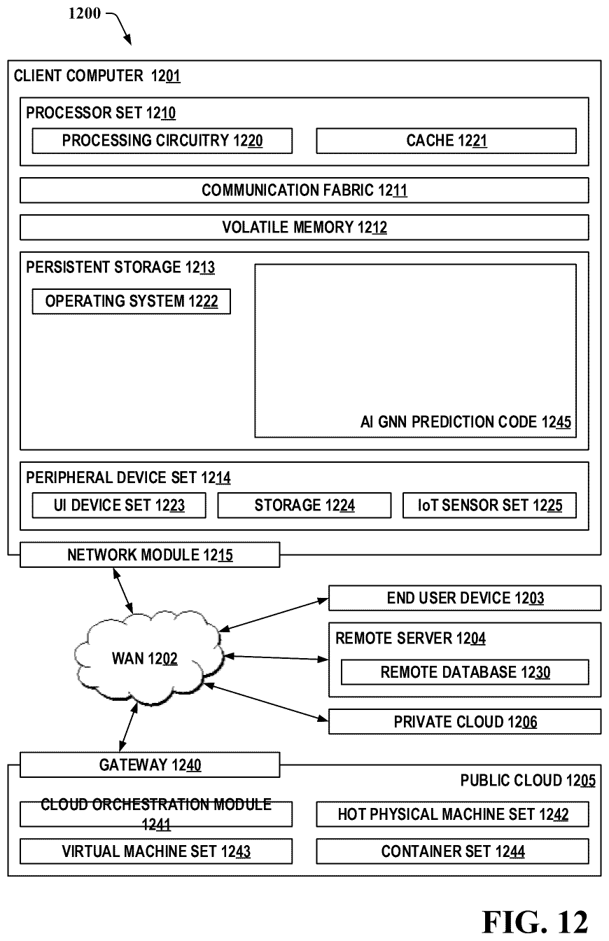

FIG. 2 illustrates a block diagram of an example, non-limiting system 200 that can utilize a multi-graph neural network framework for generalized multimodal fusion of data (e.g., medical data) for outcome prediction in accordance with one or more embodiments described herein. System 200 can comprise processor 202, memory 204, system bus 206, fusion component 208, and multi-graph neural network (MGNN) component 210. One or more aspects of the non-limiting system 200 can be described in conjunction with one or more embodiments in FIG. 3 thru FIG. 12.

Discussion first turns briefly to processor 202, memory 204 and bus 206 of system 200. For example, in one or more embodiments, system 200 can comprise processor 202 (e.g., computer processing unit, microprocessor, classical processor, and/or like processor). In one or more embodiments, a component associated with system 200, as described herein with or without reference to the one or more figures of the one or more embodiments, can comprise one or more computer and/or machine readable, writable and/or executable components and/or instructions that can be executed by processor 202 to enable performance of one or more processes defined by such component(s) and/or instruction(s).

In one or more embodiments, system 200 can comprise a computer-readable memory (e.g., memory 204) that can be operably connected to the processor 202. Memory 204 can store computer-executable instructions that, upon execution by processor 202, can cause processor 202 and/or one or more other components of system 200 (e.g., fusion component 208, and predictive MGNN component 212) to perform one or more actions. In one or more embodiments, memory 204 can store computer-executable components (e.g., fusion component 208, and/or MGNN component 212).

System 200 and/or a component thereof as described herein, can be communicatively, electrically, operatively, optically and/or otherwise coupled to one another via bus 206. Bus 206 can comprise one or more of a memory bus, memory controller, peripheral bus, external bus, local bus, and/or another type of bus that can employ one or more bus architectures. One or more of these examples of bus 206 can be employed. In one or more embodiments, system 200 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of system 200 can reside in the cloud, and/or can reside locally in a local computing environment (e.g., at a specified location(s)).

In addition to the processor 202 and/or memory 204 described above, system 200 can comprise one or more computer and/or machine readable, writable and/or executable components and/or instructions that, when executed by processor 202, can enable performance of one or more operations defined by such component(s) and/or instruction(s). System 200 can be associated with, such as accessible via, a computing environment 1200 described below with reference to FIG. 12. For example, system 200 can be associated with a computing environment 1200 such that aspects of processing can be distributed between system 200 and the computing environment 1200.

The fusion component 208 can model non-linear modality correlations within and across entities through Hirschfeld-Gebelein-Re'nyi maximal correlation (MaxCorr) embeddings that generates a multi-graph that preserves identities of modalities and entities. The multi-graph neural network (MGNN) component 210 can perform task-informed reasoning in multi-graphs, that learns parameters defining entity-modality graph connectivity and message passing in an end-to-end fashion. In an embodiment, the multi-graph neural network (MGNN) component 210 can model multi-faceted interactions between modality features. The multi-graph neural network (MGNN) component 210 can model intra and inter-entity modality relationships explicitly through a entity-modality multi-graph. The fusion component 208 can employ learnable Hirschfeld-Gebelein-Re'nyi (HGR) maximal correlations to express a multimodal dataset as a entity-modality multilayered graph for fusion.

In yet another embodiment, the multi-graph neural network (MGNN) component 210 learns task informed entity-modality multi-graph representations automatically from unstructured modality data, and can use walk operations to automatically mine predictive patterns from a multi-graph given targets under task-supervision and graph neural network (GNN) parameters.

In an embodiment, the multi-graph neural network (MGNN) component 210 is trained in a supervised fashion by employing only supra-node features and induced sub-graph edges. including both cross-modal and intra-planar edges, associated with subjects in a training set for backpropagation. During validation of the multi-layered graph neural network (MGNN) component 210, parameter estimates are frozen and edges corresponding to unseen entities are added to perform a forward pass for estimation.

The proposed innovation is a machine learning-based system that is used to generate optimum predictive graph-based inputs. More particularly, a novel multi-graph deep learning framework, i.e. the MaxCorrMGNN is presented for generalized problems of multimodal fusion in data (e.g., medical data). Going one step beyond simple statistical measures, for example, a entity-modality multi-graph allows for uncovering nuanced non-linear notions of dependence between modality features via a maximal correlation soft-HGR formulation. The sHGR formulation coupled with a learnable sparsity module allows to directly translate an abstract measure of interaction across entities and modalities in most any multimodal dataset into an entity-modality multi-graph structure for inference. Construction of multi-graph planes allows node features to retain individuality in terms of plane (modality) and entity (node-identity) in filtered Graph Neural Network representations. This admits more explainable intermediate representations in comparison to baselines, e.g, provides an ability to explicitly reason at granularity of both entities and modalities. Conversely, graph based/traditional fusion baselines collapse this information, either in multimodal representation or in inference step. This added flexibility in MaxCorrMGNN contributes to improved generalization power in practice. Finally, individual components (e.g., MaxCorr, learnable soft-thresholding, MGNN message passing) are designed to be fully differentiable deep learning operations, allowing to directly couple them end-to-end. As discussed supra, demonstrated in experiment is that this coupling is key to generalization. As such, such model makes very mild assumptions about nature of multimodal data. It is to be appreciated that general principles and machinery developed, and disclosed herein will likely be useful to a wide variety of applications beyond the medical realm.

In problems of multimodal fusion, especially for medical applications, data acquisition is a fairly contrived and expensive process. In many, real-world modalities may often be only partially observed, missing in totality, or noisy in acquisition. Simple methods such as mean based imputation may be inadequate for fine-grained reasoning. As an aim to address this, an active line of exploration is to extend the framework to handle missing, ambiguous and erroneous data and labels within multilayered graph representation. This may be achieved by leveraging statistical and graph theoretic tools that can be integrated directly into message passing walks. Finally, the multi-graph and HGR construction focuses on uncovering pairwise relationships between subjects and features. These frameworks can be extended to model complex multi-set dependencies.

Introduced is a novel multi-graph based neural framework for general inference problems in multimodal fusion. The framework leverages HGR MaxCorr formulation to convert unstructured multi-modal data into an entity-modality multi-graph. Designed is a generalized multi-graph neural network for fine-grained reasoning from such representation. The design preserves entity-modality semantics as a part of an architecture, making representations more readily interpretable rather than fully black-box as compared to conventional frameworks. The end-to-end optimization of the two components offers a viable tradeoff between flexibility, representational power, and interpretability. Demonstrated is efficacy of the MaxCorr MGNN for fusing disparate information from imaging, genomic and clinical data for outcome prediction in Tuberculosis and demonstrate consistent improvements against competing state-of-the-art baselines developed in literature. Moreover, the framework makes very few assumptions making it potentially applicable to a variety of fusion problems in other artificial intelligence (AI) domains. Finally, principles developed, and disclosed herein can be generalized and be applied to problems well beyond multimodal fusion.

Turning to FIG. 3, in the age of modern medicine, it is now possible to capture information about a patient through multiple data-rich modalities to give a holistic view of a patient's condition. In complex diseases such as cancer, tuberculosis or autism spectrum disorder, evidence for a diagnosis or treatment outcome may be present in multiple modalities such as clinical, genomic, molecular, pathological and radiological imaging. Reliable patient-tailored outcome prediction requires fusing information from modality data both within and across patients. This can be achieved by effectively modeling fine-grained and multi-faceted complex interactions between modality features. In general, this is a challenging problem as it is largely unclear what information is best captured by each modality, how best to combine modalities, and how to effectively extract predictive patterns from data.

Existing attempts to fuse modalities for outcome prediction can be divided into at least three approaches, namely, feature vector-based, statistical or graph-based approaches. The vector-based approaches perform early, intermediate, or late fusion with the late fusion approach combining results of prediction rather than fusing modality features. Due to the restrictive nature of underlying assumptions, these are often inadequate for characterizing broader range of relationships among modality features and their relevance for prediction. In statistical approaches, methods such as canonical correlation analysis and its deep learning variants directly model feature correlations either in the native representation or in a latent space. However, these are not guaranteed to learn discriminative patterns in the unsupervised setting and can suffer from scalability issues when integrated into larger predictive models. Recently, graph-based approaches have been developed which form basic or multiplexed graphs from latent embeddings derived from modality features using concatenation or weighted averaging. Task-specific fusion is then achieved through inference via message passing walks between nodes in a graph neural network. In the basic collapsed graph construction, inter-entity and intra-entity modality correlations are not fully distinguished. Conversely, in a multiplexed formulation, typically only a restricted form of multi-relational dependence is captured between nodes through vertical connections. Since the graph is defined using latent embedding directions, modality semantics are not preserved. Additionally, staged training of the graph construction and inference networks do not guarantee that the constructed graphs retain discriminable interaction patterns.

Developed is a novel end-to-end fusion framework that addresses limitations mentioned above. The Maximal Correlation Multi-Graph Neural Network, i.e. MaxCorrMGNN, is a general yet interpretable framework for problems of multimodal fusion with unstructured data. Specifically, an embodiment marries design principles of statistical representation learning with deep learning models for reasoning from multi-graphs.

FIG. 3 depicts a Maximal Correlation (MaxCorr) Formulation 300 for multimodal data fusion. It starts with inputs (x^{k}) from different modalities (e.g., DNA, images . . . ). Each modality undergoes a specific transformation (f^{l}(⋅) for modality l, f^{m}(⋅) for modality m) into a common feature space where correlations are maximized. Covariance is calculated to model relationships within and between modalities.

Significant innovations are three-fold:

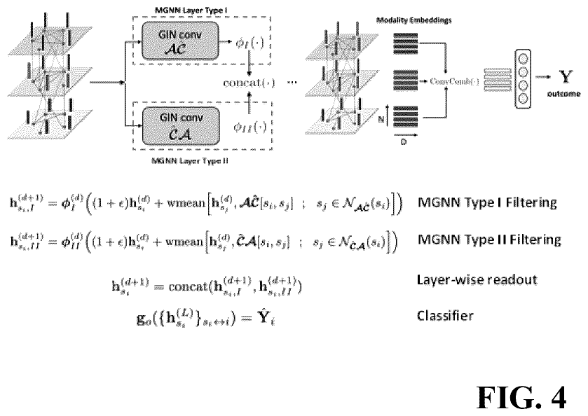

First, proposed is to model intra and inter-entity modality relationships explicitly through a novel entity-modality multi-graph as shown in FIG. 4. Edges in each layer (plane of the multi-graph) capture intra-modality relations between entities, while cross-edges between layers capture inter-modality relations across entities.

Since these relationships are not known apriori for unstructured data, proposed is to use learnable Hirschfeld-Gebelein-Re'nyi (HGR) maximal correlations. Introduced is learnable soft-thresholding to uncover salient connectivity patterns automatically. Effectively, this procedure allows to express most any multimodal dataset as an entity-modality multilayered graph for fusion.

Third, developed is a multilayered graph neural network (MGNN) from first principles for task-informed reasoning from multi-graphs.

To demonstrate generality of this approach, a framework is evaluated on a large Tuberculosis (TB) dataset for multi-outcome prediction. Through rigorous experimentation, the framework is shown to outperform several state-of-the-art graph based and traditional fusion baselines.

### MaxCorrMGNN Formulation for Multimodal Fusion

Described are four aspects of a formulation, namely, (a) multilayered graph representation, (b) formalism for maximal correlation (c) task-specific inference through graph neural networks, and (d) loss function for end-to-end learning of both graph connectivity and inference.

### Entity-Modality Multi-Graph:

Given multimodal data about entities, modeled are modality and entity information through a multi-graph as shown in FIGS. 3-4. Here nodes are grouped into multiple planes, each plane representing edge-connectivity according to an individual modality while each entity is represented by a set of corresponding nodes across layers (called a supra-node). In FIG. 3, the figure illustrates a method for constructing an entity-modality multi-graph for data fusion that integrates various data modalities, such as speech, image, and text. Feature vectors from different modalities are projected into a common space using modality-specific networks, enabling the computation of covariance and mutual correlations. The multi-graph comprises planes representing different modalities, with nodes corresponding to entities (e.g., entities) that are consistent across all modalities. Nodes (entities) are organized in planes representing different modalities (e.g., speech, images, text). Edges within each plane (colored) represent intra-modality relationships, while edges across planes (dashed) represent inter-modality relationships, while inter-modal edges (between planes) represent cross-modality relationships. SHGR correlations determine edge weights. Adaptive sparse thresholding uses a sparsity matrix to keep significant edges and remove less relevant ones. The loss function L_{SHGR} optimizes the graph structure by maximizing correlations and regularizing covariance. Adaptive sparse thresholding further refines the graph by maintaining significant connections within and between modalities. This framework enhances integration and analysis of multimodal data.

Mathematically, represented is a multi-graph as: G_M=(V,E_M), where |V_M=|V|×K are extended supra-nodes and E_M={(i,j)∈V_M×V_M} are edges between the supra-nodes. There are K modality planes, each with adjacency matrices A_((k))εR\hat{ }(P×P). K×K pairwise cross planar connections are given by C_((l,m))εR\hat{ }(P×P), where P=|V|. Edge weights can take values in range [0-1].

### HGR Maximal Correlations for Latent Multi-Graph Learning:

Recall it is desired to learn task informed entity-modality multi-graph representations automatically from unstructured modality data. To this end, developed is a framework illustrated in FIG. 3. The figure depicts a Multi-Graph Neural Network (MGNN) designed for structured inference tasks on multi-graph representations. The MGNN uses two filtering operations: MGNN Layer Type I, which processes intra-plane relationships using GIN convolutions with the adjacency matrix AĈ, and MGNN Layer Type II, which handles inter-plane relationships using GIN convolutions with the adjacency matrix ĈA. Node features are updated by considering both their own features and the weighted mean of their neighbors' features. After multiple layers, the node features from both filtering operations are concatenated. The final node representations are then fed into a classifier to predict node-level labels. This architecture captures complex multi-graph structures, enabling accurate node-level predictions.

Let

$${\{ {x}_{n}^{k} ∈ {ℛ}^{{D}_{k} \times 1} \}}_{k = 1}^{K}$$

be features from modality k for entity n. Since features from different modalities lie in different input subspaces, developed are parallel common space projections to explore dependence between them. Hirschfield, Gebelin, Rènyi (HGR) framework in statistics is known to generalize a notion of dependence to abstract and non-linear functional spaces. Such non-linear projections can be parameterized by deep neural networks.

Specifically, let a collection of modality-specific projection networks be given by {f^{k}(⋅): [symbol] ^{D}^{ₖ}^{×1}→ [symbol] ^{D}^{ₚ}^{×1}}. The HGR maximal correlation is a symmetric measure obtained by solving the following coupled pairwise constrained optimization problem:

$${sup}_{{𝒞}_{E} , {𝒞}_{Cov}} {ρ}_{HGR} ( {x}^{l} , {x}^{m} ) = {sup}_{{𝒞}_{E} , {𝒞}_{Cov}} 𝔼 [ {[ {f}^{l} ( {x}^{l} ) ]}^{T} {f}^{m} ( {x}^{m} ) ] \qquad ( 1 )$$

∀{l. m}s.t. l≠m, where [symbol] _{D}_{ₚ} is a Dₚ×Dₚ identity matrix. The constraint sets are given by:

$${𝒞}_{E} : \{ 𝔼 [ {f}^{l} ( \cdot ) ] = 𝔼 [ {f}^{m} ( \cdot ) ] = 0 \} \qquad ( 2 )$$

$${𝒞}_{Cov} : \{ Cov ( {f}^{l} ( {x}^{l} ) ) = Cov ( {f}^{m} ( {x}^{m} ) ) = {𝒥}_{{D}_{p}} \} \qquad ( 3 )$$

Approaches such as deep CCA can be thought of as a special case of this formulation which solve the whitening (empirical covariance) constraints (Eq. (3)) via explicit pairwise de-correlation.

However, for multiple modalities in large datasets, exact whitening is not scalable. To circumvent this issue, we can use the approach in Wang, L., Wu, J., Huang, S. L., Zheng, L., Xu, X., Zhang, L., Huang, J.: An efficient approach to informative feature extraction from multimodal data. In: Proceedings of the AAAI Conference on Artificial Intelligence. vol. 33, pp. 5281-5288 (2019). This formulation proposes introduces a relaxation to the exact HGR, named soft-HGR, which consists of a trace regularizer in lieu of whitening. Eq. (1) can be relaxed as an empirical minimization problem min [symbol] _{sHGR}, where the sHGR loss is:

$$\begin{matrix}{ℒ}_{sHGR} = - \frac{1}{{N}_{z}} 𝔼 [ {{f}^{l} ( {x}^{l} )}^{T} {f}^{m} ( {x}^{m} ) ] + \frac{1}{2 {N}_{z}} Tr [ Cov [ {f}^{l} ( {x}^{l} ) ] Cov [ {f}^{m} ( {x}^{m} ) ] ] \\ = - \frac{1}{{N}_{z}} ( {\sum }_{l , m = 1}^{K} [ \begin{matrix}{\sum }_{n = 1}^{N} \frac{{{f}^{l} ( {x}_{n}^{l} )}^{T} {f}^{m} ( {x}_{n}^{m} )}{( N - 1 )} - \\ \frac{Tr [ Cov [ {f}^{l} ( {x}^{l} ) ] Cov [ {f}^{m} ( {x}^{m} ) ] ]}{2}\end{matrix} ] ) l \neq m\end{matrix} \qquad ( 4 )$$

The expectation under the functional transformations [symbol] [f^{l}(x^{l})]= [symbol] [f^{m}(x^{m})]=0 is enforced step-wise by mean subtraction during optimization. Here, Cov(⋅) is the empirical covariance matrix. We parameterize {f^{k}(⋅)} as a simple two layered fully connected neural network with a normalization factor as N_{z}=M(M−1).

By design, the MaxCorr formulation allows us to utilize the correlation

$${ρ}_{sHGR} ( {x}_{i}^{l} , {x}_{j}^{m} )$$

(computed after solving Eq. (4)) to model dependence between entities i and j according to the l and m modality features in a general setting. The absolute value of this correlation measure define the edge weights between nodes in the entity-modality multi-graph.

### Learnable Adaptive Sparsity:

Additionally, we would like to have our learning framework automatically discover and retain salient edges that are relevant for prediction. To encourage sparsity in the edges, we utilize a learnable soft-thresholding formulation. We first define a symmetric block sparsity matrix S. Since edge weights in the multi-graph are in the range [0-1], we normalize it through the sigmoid function as \tilde{S}=\tilde{S}^{T}=Sigmoid(S)∈ [symbol] ^{K×K}. The entries of the soft-thresholding matrix \tilde{S}[l, m] define learnable thresholds for the cross modal connections when l≠m and in-plane connections when l=m. Finally, the cross modal edges and in-plane edges of the multi-graph are given by:

$${C}_{( l , m )} [ i , j ] = ReLU ( {\tilde{ρ}}_{sHGR} ( {x}_{i}^{l} , {x}_{j}^{m} ) - \tilde{S} [ l , m ] ) \qquad ( 5 )$$

$${A}_{k} [ i , j ] = ReLU ( {\tilde{ρ}}_{sHGR} ( {x}_{i}^{k} , {x}_{j}^{k} ) - \tilde{S} [ k , k ] ) \qquad ( 6 )$$

with \tilde{ρ}_{sHGR}=|ρ_{sHGR}| respectively. The adjacency matrices A₍ₖ₎ model the dependence within the features of modality k, while the cross planar matrices {C_{(l,m)}} capture interactions across modalities. Overall, S acts as a regularizer that suppresses noisy weak dependencies. These regularization parameters are automatically inferred during training along with the MaxCorr projection parameters {f^{k}(⋅)}. This effectively adds just K(K+1) learnable parameters to the MaxCorrMGNN.

### Multi-Graph Neural Network:

As a standalone optimization, the MaxCorr block is not guaranteed to learn discriminative projections of modality features. A natural next step is to couple the multi-graph representation learning with the classification task. Graph Neural Networks have recently become popular tools for reasoning from graphs and graph-signals. Given the entity-modality multi-graph, we design an extension of traditional graph neural networks to multi-graphs for inference tasks.

Conventional GNNs filter information based on the graph topology (e.g., the adjacency matrix) to map the node features to the targets based on graph traversals. Conceptually, cascading l GNN layers is analogous to filtered information pooling at each node from its l-hop neighbors inferred from the powers of the graph adjacency matrix. These neighborhoods can be reached by seeding walks on the graph starting at the desired node. Inspired by this design, we craft a multi-graph neural network (FIG. 4) for outcome prediction. Our MGNN generalizes structured message passing to the multi-graph in a manner similar to those done for multiplexed graphs. Notably, the formulation is more general, as it avoids using strictly vertical interaction constraints between entities across modalities.

Initially is to construct two supra-adjacency matrices to perform walks on multi-graph [symbol] _{M} for fusion. The first is the intra-modality adjacency matrix [symbol] ∈ [symbol] ^{PK×PK}. The second is the inter-modality connectivity matrix [symbol] ∈ [symbol] ^{PK×PK}, each defined block-wise. Mathematically, this is expressed as:

$$𝒜 = {⊕}_{k} {A}_{( k )} \qquad ( 7 )$$

$$\hat{𝒞} : \hat{𝒞} [ lP : ( l + 1 ) P , mP : ( m + 1 ) P ] = {C}_{( l , m )} 1 ( l \neq m ) + {𝒥}_{P} 1 ( l = m ) \qquad ( 8 )$$

where ⊕ is a direct sum operation and 1 denotes indicator function. By design, [symbol] is block-diagonal and allows for within-planar (intra-modality) transitions between nodes. The off-diagonal blocks of [symbol] , i.e. C_{(l,m)}, capture transitions between nodes as per cross-planar (inter-modality) relationships.

### MGNN Message Passing Walks:

Walks on [symbol] _{M} combine within and across planar steps to reach a entity supra-node sⱼ from another supra-node sᵢ (sᵢ, sⱼ∈ [symbol] _{M}). Multi-hop neighborhoods and transitions are characterized using factorized operations involving [symbol] and [symbol] . A multi-graph walk can be performed via two types of distinct steps, e.g., (1) an isolated intra-planar transition or (2) a transition involving an inter-planar step either before or after a within-planar step. These steps can be exhaustively recreated via two factorizations: (I) after one intra-planar step, the walk may continue in the same modal plane or hop to a different one via [symbol] and (II) the walk may continue in the current modal plane or hop to a different plane before the intra-planar step via [symbol] .

The Multi-Graph Neural Network (MGNN) uses these walk operations to automatically mine predictive patterns from the multi-graph given the targets (task-supervision) and the GNN parameters. For supra-node sᵢ,

$${h}_{{s}_{i}}^{( d )} ∈ {ℛ}^{{D}^{d} \times 1}$$

is the feature (supra)-embedding at MGNN depth d. The forward pass operations of the MGNN are as follows:

$${h}_{{s}_{i} , I}^{( d + 1 )} = {ϕ}_{I}^{( d )} ( ( 1 + ϵ ) {h}_{{s}_{i}}^{( d )} + w mean [ {h}_{{s}_{j}}^{( d )} , 𝒜 \hat{𝒞} [ {s}_{i} , {s}_{j} ] ; {s}_{j} ∈ {𝒩}_{𝒜 \hat{𝒞}} ( {s}_{i} ) ] ) \qquad ( 9 )$$

$${h}_{{s}_{i} , II}^{( d + 1 )} = {ϕ}_{II}^{( d )} ( ( 1 + ϵ ) {h}_{{s}_{i}}^{( d )} + w mean [ {h}_{{s}_{j}}^{( d )} , \hat{𝒞} 𝒜 [ {s}_{i} , {s}_{j} ] ; {s}_{j} ∈ {𝒩}_{\hat{𝒞} 𝒜} ( {s}_{i} ) ] ) \qquad ( 10 )$$

$${h}_{{s}_{i}}^{( d + 1 )} = concat ( {h}_{{s}_{i} , I}^{( d + 1 )} , {h}_{{s}_{i} , II}^{( d + 1 )} ) \qquad ( 11 )$$

$${g}_{o} ( {\{ {h}_{{s}_{i}}^{( L )} \}}_{{s}_{i} ↔ i} ) = {\hat{Y}}_{i} \qquad ( 12 )$$

At the input layer, we have

$${h}_{{s}_{i}}^{( 0 )} = {f}^{k} ( {x}_{i}^{k} )$$

computed from the modality features for entity i after the sHGR transformation from the corresponding modality k. Supra-embeddings are concatenated as input to the next layer e.g.,

$${h}_{{s}_{i}}^{( d + 1 )} .$$

Eqs. (9-10) denote the Graph Isomorphism Network (GIN) with

$$\{ {ϕ}_{I}^{( d )} ( \cdot ) , {ϕ}_{II}^{( d )} ( \cdot ) \}$$

as layerwise linear transformations. This performs message passing on the multi-graph using the neighborhood relationships and normalized edge weights from the walk matrices in the weighted mean operation wmean(⋅).

From the interpretability standpoint, these operations keep semantics of embeddings intact at both entities and modality level throughout MaxCorrMGNN transformations. Finally, gₒ(⋅) is a graph readout network that maps to one-hot encoded outcome Y, which performs a convex combination of filtered modality embeddings, followed by a linear readout.

### End-To-End Learning Through Task Supervision:

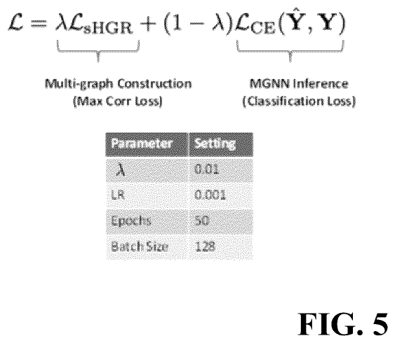

Turning to FIG. 5, piecing together constituent components, e.g., latent graph learning and MGNN inference module, optimized is the following coupled objective function:

$$ℒ = {λℒ}_{sHGR} + ( 1 - λ ) {ℒ}_{C E} ( \hat{Y} , Y ) \qquad ( 13 )$$

with λ∈[0,1] being a tradeoff parameter and [symbol] _{CE}(⋅) being the cross entropy loss. The parameters

$$\{ \{ {f}^{k} ( \cdot ) \} , S , \{ {ϕ}_{I}^{( d )} ( \cdot ) , {ϕ}_{II}^{( d )} ( \cdot ) , ϵ \} , {g}_{o} ( \cdot ) \}$$

of the framework are jointly learned via standard backpropagation.

### Inductive Learning for Multi-Graph Neural Networks:

The multi-graph is designed to have entities as the nodes, which requires adapting training to accommodate an inductive learning setup. Specifically, MaxCorrMGNN is trained in a fully supervised fashion by extending principles outlined in Cosmo, L., Kazi, A., Ahmadi, S. A., Navab, N., Bronstein, M.: Latent-graph learning for disease prediction. In: Medical Image Computing and Computer Assisted Intervention—MICCAI 2020: 23rd International Conference, Lima, Peru, Oct. 4-8, 2020, Proceedings, Part II 23. pp. 643-653. Springer (2020) for multi-graphs. During training, typically used are only supra-node features and induced sub-graph edges (including both cross-modal and intra-planar edges) associated with entities in a training set for backpropagation. During validation/testing, parameter estimates are freezed and edges are added in corresponding to unseen patients to perform a forward pass for estimation. This procedure ensures that no double dipping occurs in hyper-parameter estimation, nor in an evaluation step. Additionally, while not the focus of this application, this procedure allows for extending prediction and training to an online setting, where new entity/modality information may dynamically become available.

### Implementation Details:

MaxCorr projection networks f^{l}(⋅) are implemented as a simple three layered neural network with hidden layer width of 32 and output Dₚ=64 and LeakyReLU activation (negative slope=0.01). The MGNN layers are Graph Isomorphism Network (GIN) with ReLU activation and linear readout (width: 64) and batch normalization. gₒ(⋅) implements a convex combination of the modality embeddings followed by a linear layer. An ADAMw optimizer is utilized and trained on a 64 GB CPU RAM, 2.3 GHz 16-Core Intel i9 machine (18-20 min training time per run). Hyperparameters are set for our model (and baselines) using grid-search to λ=0.01, learning rate=0.0001, weight decay=0.001, epochs=50, batch size=128 after pre-training the network on the sHGR loss alone for 50 epochs. Frameworks are implemented on a Deep Graph Library (v=0.6.2) in PyTorch (v=0.10.1).

### Experiments and Results

### Data and Preprocessing

The model was evaluated on the Tuberculosis Data Exploration Portal consisting of 3051 patients with five different treatment outcomes (Died, Still on treatment, Completed, Cured, or Failure) with the class frequencies as: 0.21/0.11/0.50/0.10/0.08 respectively and five modalities. Data was processed according to a procedure outlined in D'Souza, N. S., Wang, H., Giovannini, A., Foncubierta-Rodriguez, A., Beck, K. L., Boyko, O., Syeda-Mahmood, T.: Fusing modalities by multiplexed graph neural networks for outcome prediction in tuberculosis. In: Medical Image Computing and Computer Assisted Intervention—MICCAI 2022: 25th International Conference, Singapore, Sep. 18-22, 2022, Proceedings, Part VII. pp. 287-297. Springer (2022).

For each subject, there are features available from demographic, clinical, regimen and genomic recordings with chest CTs available for 1015 of them. There are a total of 4081 genomic, 29 demographic, 1726 clinical, 233 regimen features that are categorical, and 2048 imaging and 8 miscellaneous continuous features. Information that may directly be related to treatment outcomes, e.g., drug resistance type, were removed from clinical and regimen features.

For genomic data, 81 single nucleotide polymorphisms (SNPs) from causative organisms Mycobacterium tuberculosis (Mtb) known to be related to drug resistance were used. For 275 of the subjects, assembled raw genome sequence from NCBI Sequence Read Archive. This provides a more fine-grained description of the biological sequences of causative pathogen. Briefly, a de novo assembly process was performed on each Mtb genome to yield protein and gene sequences. InterProScan was utilized to further process protein sequences and extract functional domains, e.g., sub-sequences located within protein's amino acid chain responsible for enzymatic bioactivity of a protein. This provides a total of 4000 functional genomic features. Finally, for an imaging modality, a lung was segmented via multi-atlas segmentation followed by a pre-trained DenseNet to extract a 1024-dimensional feature vector for each axial slice intersecting the lung. The mean and maximum of each feature were then assembled to give a total of 2048 features. Missing features are imputed from the training cohort using mean imputation for all runs.

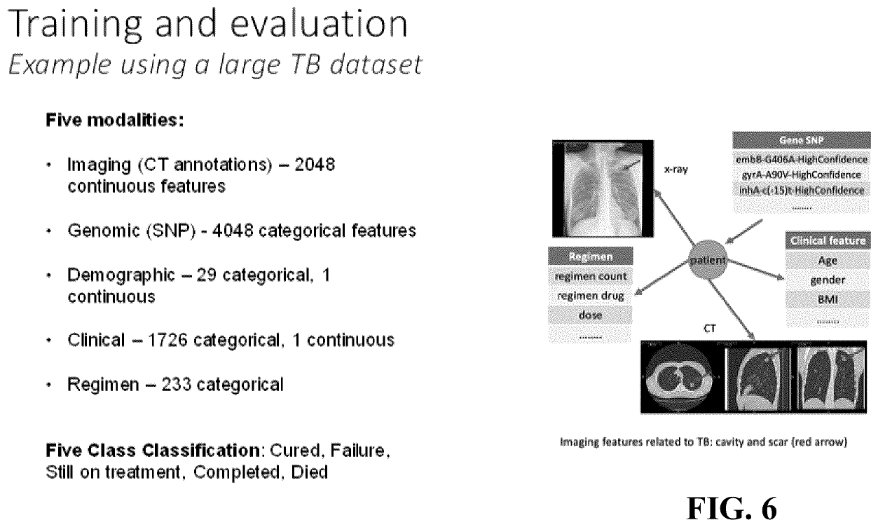

FIG. 6 presents a training and evaluation process using a large tuberculosis (TB) dataset. The dataset includes five modalities: imaging (2048 continuous features), genomic (4048 categorical features), demographic (29 categorical and 1 continuous feature), clinical (1726 categorical and 1 continuous feature), and regimen (233 categorical features). The goal is to predict five possible treatment outcomes: cured, failure, still on treatment, completed, and died. This multimodal dataset, with its mix of continuous and categorical features, poses a challenging fusion task. The figure demonstrates the effectiveness of the proposed fusion framework compared to existing methods in handling such complex and diverse data.

### Evaluation Metrics:

Since there is a five-class classification task, we evaluate prediction performance of the MaxCorrMGNN and the baselines using the AU-ROC (Area Under the Receiver Operating Curve) metric. Given the prediction logits, this metric is computed both class-wise and as a weighted average. Higher per-class and overall AU-ROC indicate improved performance. For experiments, 10 randomly generated train/validation/test splits with ratio 0.7/0.1/0.2 was utilized to train the model and each baseline.

Finally, statistical differences between the baselines and our method are measured according to a DeLong test computed class-wise. See e.g., DeLong, E. R., DeLong, D. M., Clarke-Pearson, D. L.: Comparing the areas under two or more correlated receiver operating characteristic curves: a nonparametric approach. Biometrics pp. 837-845 (1988) This test is a sanity check to evaluate whether perceived differences in model performance are robust to sampling.

### Baseline Comparisons

A comprehensive evaluation of our framework was performed for the problem of multimodal fusion. Baseline comparisons can be grouped into three categories, namely, (1) Single Modality Predictors/No Fusion (2) State-of-the-art Conventional including early/late/intermediate fusion and Latent-Graph Learning models from literature (3) Ablation Studies.

Ablation studies evaluate efficacy of three main constituents of the MaxCorrMGNN, e.g., MaxCorr graph construction, Multi-Graph Neural Network and end-to-end optimization.
Single Modality: For this comparison, we run predictive deep-learning models on the individual modality features without fusing them as a benchmark. We use a two layered multi-layered perception (MLP) with hidden layer widths as 400 and 20 and LeakyReLU activation (neg. slope=0.01).
Early Fusion: For early fusion, individual modality features are first concatenated and then fed through a neural network. The predictive model has the same architecture as the previous baseline.
Uncertainty Based Late Fusion: We combine the predictions from the individual modalities in the previous baseline using a state-of-the-art late fusion framework in Wang, H., Subramanian, V., Syeda-Mahmood, T.: Modeling uncertainty in multimodal fusion for lung cancer survival analysis. In: 2021 IEEE 18th International Symposium on Biomedical Imaging (ISBI). pp. 1169-1172. IEEE (2021). This model estimates uncertainty in individual classifiers to improve robustness of outcome prediction. Unlike the subject work, patient-modality dependence is not explicitly modeled as modality predictions are only combined after individual modality-specific models have been trained. Hyperparameters are set according to Wang, H., Subramanian, V., Syeda-Mahmood, T.: Modeling uncertainty in multimodal fusion for lung cancer survival analysis. In: 2021 IEEE 18th International Symposium on Biomedical Imaging (ISBI). pp. 1169-1172. IEEE (2021).
Graph Based Intermediate Fusion: This is a graph based neural framework that achieved state-of-the-art performance on multimodal fusion on unstructured data. This model follows a two step procedure. For each patient, this model first converts the multimodal features into a fused binary multiplex graph (multi-graph where all blocks of [symbol] are strictly diagonal) between features. The graph connectivity is learned in an unsupervised fashion through auto-encoders. Following this, a multiplexed graph neural network is used for inference. Hyperparameters are set according to D'Souza, N. S., Wang, H., Giovannini, A., Foncubierta-Rodriguez, A., Beck, K. L., Boyko, O., Syeda-Mahmood, T.: Fusing modalities by multiplexed graph neural networks for outcome prediction in tuberculosis. In: Medical Image Computing and Computer Assisted Intervention—MICCAI 2022: 25th International Conference, Singapore, Sep. 18-22, 2022, Proceedings, Part VII. pp. 287-297. Springer (2022). While this framework takes a graph based approach to fusion, the construction of the graph is not directly coupled with the task supervision.
Latent Graph Learning: This baseline was developed for fusing multimodal data for prediction. It introduces a latent patient-patient graph learning from concatenated modality features via a graph-attention (GAT-like Veličković, P., Cucurull, G., Casanova, A., Romero, A., Lio, P., Bengio, Y.: Graph attention networks. arXiv preprint arXiv:1710.10903 (2017)) formulation. However, unlike the subject model, feature concatenation does not distinguish between intra- and inter-modality dependence across patients e.g., it constructs a single-relational (collapsed) graph that is learned as a part of the training.
sHGR+ANN: This is a state-of-the-art multimodal fusion framework that also utilizes sHGR formulation to infer multi-modal data representations. However, instead of constructing a patient-modality graph, projected features are combined via concatenation. Then, a two layered MLP (hidden size: 200) maps to outcomes, with two objectives trained end-to-end. This baseline can be thought of as an ablation that evaluates benefit of using the multi-graph neural network for fine-grained reasoning. Additionally, this and the previous framework helps evaluate benefit of patient-modality multi-graph representation for fusion.
MaxCorrMGNN w/o sHGR: Through this comparison, evaluated is the need for using soft HGR formulation to construct a latent multi-graph. Keeping the architectural components consistent with the subject model, set λ=0 in Eq. (13). Note that this ablation effectively converts the multi-graph representation learning into a modality specific self/cross attention learning, akin to graph transformers. Overall, this framework helps evaluate benefit of MaxCorr formulation for latent multi-graph learning.
Decoupled MaxCorrMGNN: Finally, this ablation is designed to examine benefit of coupling the MaxCorr and MGNN into a coupled objective. Therefore, instead of an end-to-end training, sHGR optimization is run first, followed by MGNN for prediction.

Displayed is mean per-class and weighted average AU-ROC and standard errors for TB outcome prediction against (Left): Single Modality Predictors (Middle): Traditional and Graph Based Fusion Frameworks (Right): Ablations of the MaxCorrMGNN. * indicate comparisons against the MaxCorrMGNN according to the DeLong test that achieve statistical significance (p<0.01).

### Outcome Prediction Performance:

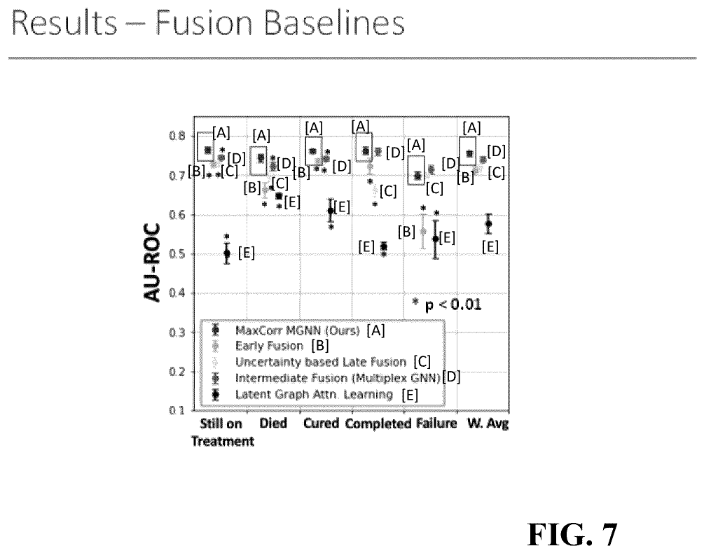

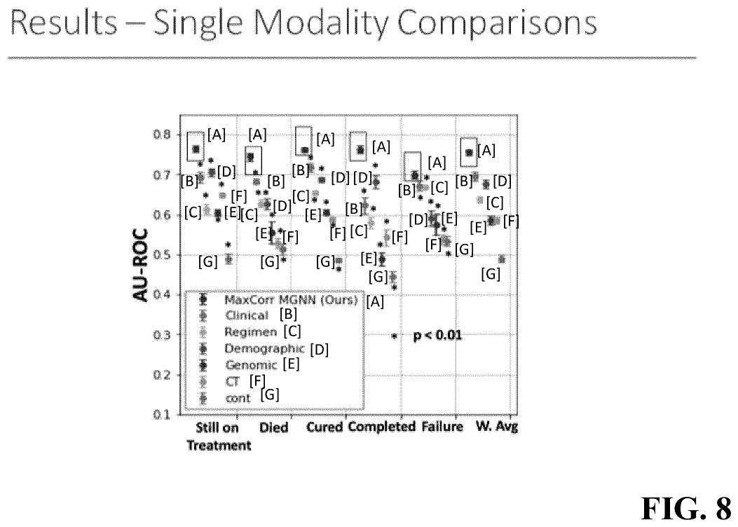

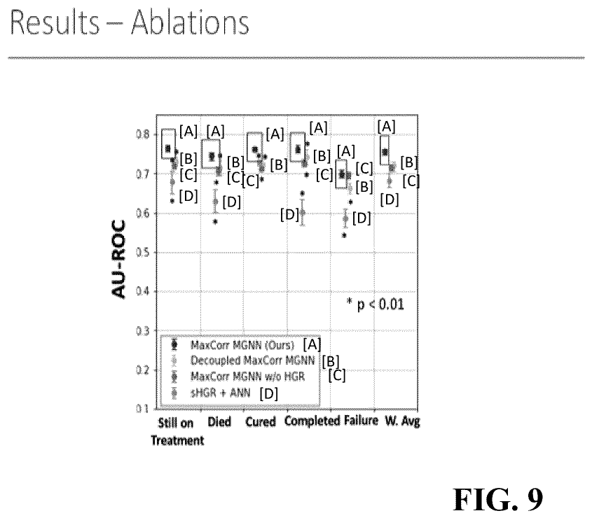

FIGS. 7-9 illustrate outcome prediction performance of the subject framework against single modality predictors (FIG. 7), state-of-the-art fusion frameworks (FIG. 8), and ablated versions of an embodiment model (FIG. 9). Comparisons marked with * achieve a statistical significance threshold of p<0.01 across runs as per the DeLong test. Note that the subject fusion framework outperforms all of the single modality predictors by a large margin. Moreover, the traditional and graph-based fusion baselines also provide improved performance against the single modality predictors. Taken together, these observations highlight the need for fusion of multiple modalities for outcome prediction in TB. This observation is consistent with findings in treatment outcome prediction literature in TB.

FIG. 7 compares the proposed MaxCorr MGNN method against traditional and graph-based fusion frameworks for tuberculosis (TB) outcome prediction. The comparison includes early fusion, uncertainty-based late fusion, intermediate fusion (Multiplex GNN), and latent graph attention learning. The figure displays the mean per-class and weighted average AU-ROC scores, with standard errors for five outcome classes: still on treatment, died, cured, completed, and failure. MaxCorr MGNN shows a significant improvement in AU-ROC metrics, as indicated by the red boxes, achieving statistical significance (p<0.01) in several cases. This highlights the superior performance of the proposed method over existing fusion frameworks.

FIG. 8 compares the performance of the proposed MaxCorr MGNN method against single modality predictors for tuberculosis (TB) outcome prediction. The modalities evaluated include clinical, regimen, demographic, genomic, CT, and continuous (cont) features. The mean per-class and weighted average AU-ROC scores, along with standard errors, are displayed for five outcome classes: still on treatment, died, cured, completed, and failure. MaxCorr MGNN consistently outperforms individual modality classifiers, highlighting a significant performance gap. The results show that the fusion methodology offers superior predictive accuracy compared to single modality approaches, with several instances achieving statistical significance (p<0.01) as indicated by the markers.

FIG. 9 presents results of ablation studies for the MaxCorr MGNN method, evaluating the contributions of different components to TB outcome prediction. The comparisons include: the complete MaxCorr MGNN model, a decoupled MaxCorr MGNN model with separated loss function terms, a version without the HGR statistical correlation formulation, and a model using standard artificial neural networks (sHGR+ANN). The figure displays the mean per-class and weighted average AU-ROC scores, with standard errors, for five outcome classes: still on treatment, died, cured, completed, and failure. The MaxCorr MGNN model consistently outperforms other ablation versions, demonstrating the effectiveness of its integrated loss function and graph neural network structure. Statistically significant improvements (p<0.01) are indicated by markers, highlighting the superiority of the full MaxCorr MGNN framework.

The MaxCorrMGNN also provides improved performance when compared to all of the fusion baselines, with most comparisons achieving statistical significance thresholds. While the Early Fusion and Uncertainty based Late fusion networks provide marked improvements over single modality predictions, but still fail to reach the performance level of our model. This is likely due to their limited ability to leverage subtle patient-specific cross-modal interactions.

On the other hand, the latent graph learning in models connectivity between subjects as a part of the supervision Cosmo, L., Kazi, A., Ahmadi, S. A., Navab, N., Bronstein, M.: Latent-graph learning for disease prediction. In: Medical Image Computing and Computer Assisted Intervention—MICCAI 2020: 23rd International Conference, Lima, Peru, Oct. 4-8, 2020, Proceedings, Part II 23. pp. 643-653. Springer (2020). However, this method collapses the different types of dependence into one relation-type, which may be too restrictive for fusion applications. The intermediate fusion framework of D'Souza, N. S., Wang, H., Giovannini, A., Foncubierta-Rodriguez, A., Beck, K. L., Boyko, O., & Syeda-Mahmood, T. (2022, September). Fusing modalities by multiplexed graph neural networks for outcome prediction in tuberculosis. In International Conference on Medical Image Computing and Computer-Assisted Intervention (pp. 287-297). Cham: Springer Nature Switzerland was designed to address these limitations by the use of multiplex graphs. However, the artificial separation between the graph construction and inference steps may not inherently extract discriminative multi-graph representations, which could explain the performance gap against our framework.

Finally, the three ablations, the sHGR+ANN, MaxCorrMGNN w/o sHGR, Decoupled MaxCorrMGNN help us systematically examine the three building blocks of our framework, e.g., MGNN and MaxCorr networks individually as well as the end-to-end training of the two blocks. We observe a notable performance drop in these baselines, which reinforces the principles we considered in carefully designing the individual components. In fact, the comparison against the Decoupled MaxCorrMGNN illustrates that coupling the two components into a single objective is key to obtaining improved representational power for predictive tasks. Taken together, our results suggest that the MaxCorrMGNN is a powerful framework for multimodal fusion of unstructured data.

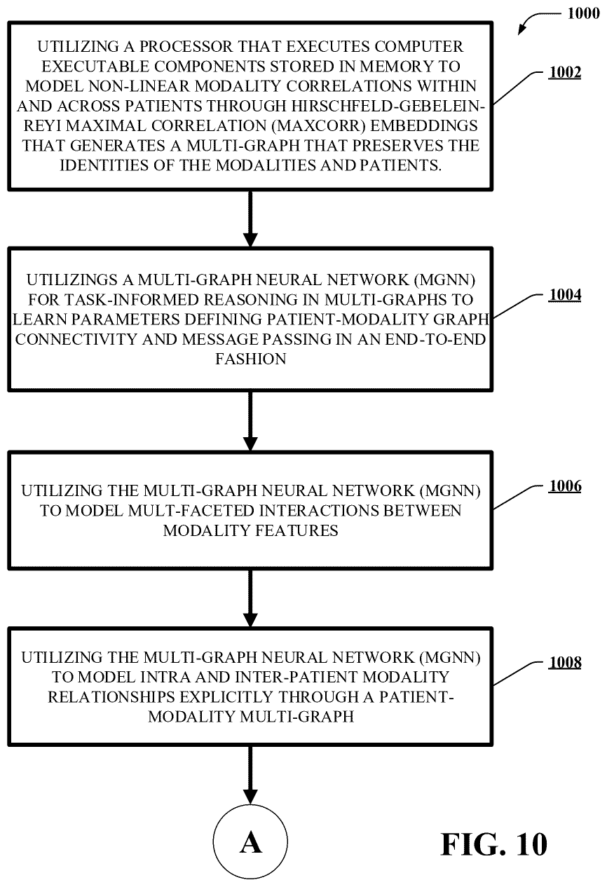

FIG. 10 illustrates a flow diagram of an example, non-limiting method 1000 that can facilitate a multi-graph neural network for outcome prediction in accordance with one or more embodiments described herein. Repetitive description of like elements and/or processes employed in respective embodiments is omitted for sake of brevity. The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions. Furthermore, in various embodiments, one or more blocks may not be necessary for a given implementation and therefore not executed or required.

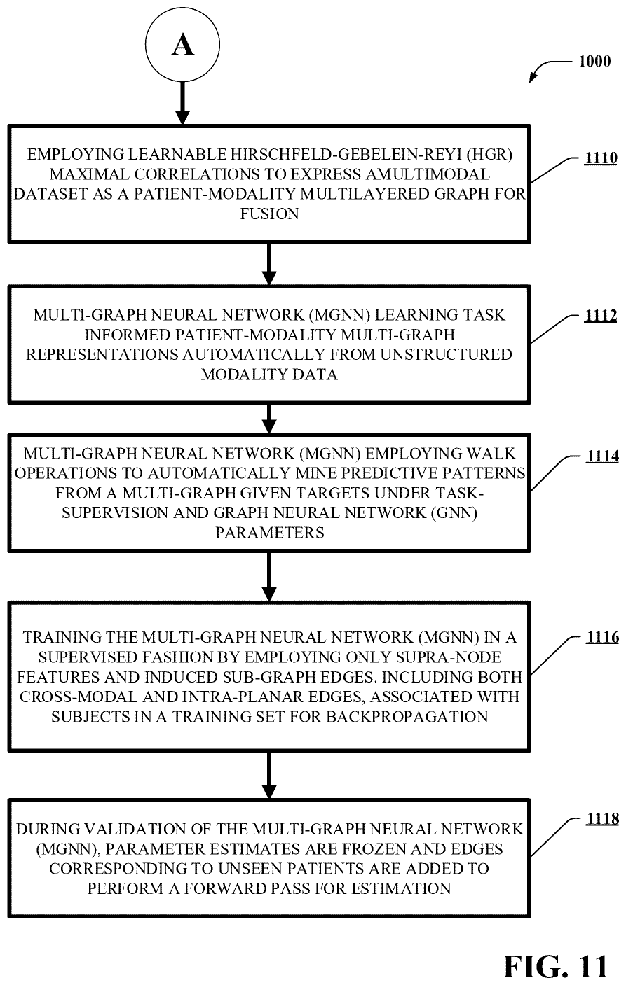

Act 1002 of the method 1000 comprises utilizing a processor that executes computer executable components stored in memory to model non-linear modality correlations within and across entities through Hirschfeld-Gebelein-Re'nyi maximal correlation (MaxCorr) embeddings that generates a multi-graph that preserves the identities of the modalities and entities. Act 1004 comprises utilizings a multi-graph neural network (MGNN) for task-informed reasoning in multi-graphs to learn parameters defining entity-modality graph connectivity and message passing in an end-to-end fashion. Act 1006 comprises utilizing the multi-graph neural network (MGNN) to model multi-faceted interactions between modality features. Act 1008 comprises utilizing the multi-graph neural network (MGNN) to model intra and inter-entity modality relationships explicitly through a entity-modality multi-graph. Acts associated with the methodology are further depicted on FIG. 11. Act 1110 comprises employing learnable Hirschfeld-Gebelein-Re'nyi (HGR) maximal correlations to express a multimodal dataset as a entity-modality multilayered graph for fusion. Act 1112 comprises the multi-graph neural network (MGNN) learning task informed entity-modality multi-graph representations automatically from unstructured modality data. Act 1114 comprises the multi-graph neural network (MGNN) employing walk operations to automatically mine predictive patterns from a multi-graph given targets under task-supervision and graph neural network (GNN) parameters. Act 1116 comprises training the multi-graph neural network (MGNN) in a supervised fashion by employing only supra-node features and induced sub-graph edges. including both cross-modal and intra-planar edges, associated with entities in a training set for backpropagation. Act 1018 comprises during validation of the multi-graph neural network (MGNN), parameter estimates are frozen and edges corresponding to unseen entities are added to perform a forward pass for estimation.

We have developed a novel multi-graph deep learning framework, i.e. the MaxCorrMGNN for generalized problems of multimodal fusion in medical data. Going one step beyond simple statistical measures, the entity-modality multi-graph allows us to uncover nuanced non-linear notions of dependence between modality features via the maximal correlation soft-HGR formulation. The sHGR formulation coupled with the learnable sparsity module allow us to directly translate an abstract measure of interaction across entities and modalities in any multimodal dataset into a entity-modality multi-graph structure for inference. The construction of the multi-graph planes allow the node features to retain their individuality in terms of the plane (modality) and entity (node-identity) in the filtered Graph Neural Network representations. This admits more explainable intermediate representations in comparison to the baselines, i.e. provides us with the ability to explicitly reason at the granularity of both the entities and modalities. Conversely, the graph based/traditional fusion baselines collapse this information, either in the multimodal representation or in the inference step. We believe that this added flexibility in the MaxCorrMGNN contributes to the improved generalization power in practice. Finally, all the individual components (i.e. MaxCorr, learnable soft-thresholding, MGNN message passing) are designed to be fully differentiable deep learning operations, allowing us to directly couple them end-to-end. We demonstrate in experiment that this coupling is key to generalization. As such, this model makes very mild assumptions about the nature of the multimodal data. The general principles and machinery developed in this work would likely be useful to a wide variety of applications beyond the medical realm.

In problems of multimodal fusion, especially for medical applications, data acquisition is a fairly contrived and expensive process. In many real-world modalities may often be only partially observed, missing in totality, or noisy in acquisition. Simple methods such as mean based imputation may be inadequate for fine-grained reasoning. As an aim to address this, an active line of exploration is to extend the framework to handle missing, ambiguous and erroneous data and labels within the multilayered graph representation. This may be achieved by leveraging statistical and graph theoretic tools that can be integrated directly into the message passing walks. Finally, the multi-graph and HGR construction focuses on uncovering pairwise relationships between subjects and features. A future direction would be to extend these frameworks to model complex multi-set dependencies.

We have introduced a novel multi-graph based neural framework for general inference problems in multimodal fusion. Our framework leverages the HGR MaxCorr formulation to convert unstructured multi-modal data into a entity-modality multi-graph. We design a generalized multi-graph neural network for fine-grained reasoning from this representation. Our design preserves the entity-modality semantics as a part of the architecture, making our representations more readily interpretable rather than fully black-box. The end-to-end optimization of the two components offers a viable tradeoff between flexibility, representational power, and interpretability. We demonstrate the efficacy of the MaxCorr MGNN for fusing disparate information from imaging, genomic and clinical data for outcome prediction in Tuberculosis and demonstrate consistent improvements against competing state-of-the-art baselines developed in literature. Moreover, the framework makes very few assumptions making it potentially applicable to a variety of fusion problems in other AI domains. Finally, the principles developed in this paper are general and can potentially be applied to problems well beyond multimodal fusion.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

FIG. 12 illustrates a block diagram of an example, non-limiting, operating environment in which one or more embodiments described herein can be facilitated. FIG. 12 and the following discussion are intended to provide a general description of a suitable operating environment 1200 in which one or more embodiments described herein at FIGS. 1-9 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1200 contains an example of an environment for the execution of at least some of the computer code involved in performing the inventive methods, such as AI GNN prediction code 1245. In addition to block 1245, computing environment 1200 includes, for example, computer 1201, wide area network (WAN) 1202, end user device (EUD) 1203, remote server 1204, public cloud 1205, and private cloud 1206. In this embodiment, computer 1201 includes processor set 1210 (including processing circuitry 1220 and cache 1221), communication fabric 1211, volatile memory 1212, persistent storage 1213 (including operating system 1222 and block 1245, as identified above), peripheral device set 1214 (including user interface (UI), device set 1223, storage 1224, and Internet of Things (IoT) sensor set 1225), and network module 1215. Remote server 1204 includes remote database 1230. Public cloud 1205 includes gateway 1240, cloud orchestration module 1241, host physical machine set 1242, virtual machine set 1243, and container set 1244.

COMPUTER 1201 may take the form of a desktop computer, laptop computer, tablet computer, smart phone, smart watch or other wearable computer, mainframe computer, quantum computer or any other form of computer or mobile device now known or to be developed in the future that can run a program, accessing a network or querying a database, such as remote database 1230. As is well understood in the art of computer technology, and depending upon the technology, performance of a computer-implemented method may be distributed among multiple computers and/or between multiple locations. On the other hand, in this presentation of computing environment 1200, detailed discussion is focused on a single computer, specifically computer 1201, to keep the presentation as simple as possible. Computer 1201 may be in a cloud, even though it is not shown in a cloud in FIG. 12. On the other hand, computer 1201 is not required to be in a cloud except to any extent as may be affirmatively indicated.

PROCESSOR SET 1210 includes one, or more, computer processors of any type now known or to be developed in the future. Processing circuitry 1220 may be distributed over multiple packages, for example, multiple, coordinated integrated circuit chips. Processing circuitry 1220 may implement multiple processor threads and/or multiple processor cores. Cache 1221 is memory that is in the processor chip package(s) and is typically used for data or code that should be available for rapid access by the threads or cores running on processor set 1210. Cache memories are typically organized into multiple levels depending upon relative proximity to the processing circuitry. Alternatively, some, or all, of the cache for the processor set may be located “off chip.” In some computing environments, processor set 1210 may be designed for working with qubits and performing quantum computing.

Computer readable program instructions are typically loaded onto computer 1201 to cause a series of operational steps to be performed by processor set 1210 of computer 1201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1221 and the other storage media discussed below. The program instructions, and associated data, are accessed by processor set 1210 to control and direct performance of the inventive methods. In computing environment 1200, at least some of the instructions for performing the inventive methods may be stored in block 1245 in persistent storage 1213.

COMMUNICATION FABRIC 1211 is the signal conduction paths that allow the various components of computer 1201 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1212 is any type of volatile memory now known or to be developed in the future. Examples include dynamic type random access memory (RAM) or static type RAM. Typically, the volatile memory is characterized by random access, but this is not required unless affirmatively indicated. In computer 1201, the volatile memory 1212 is in a single package and is internal to computer 1201, but, alternatively or additionally, the volatile memory may be distributed over multiple packages and/or located externally with respect to computer 1201.

PERSISTENT STORAGE 1213 is any form of non-volatile storage for computers that is now known or to be developed in the future. The non-volatility of this storage means that the stored data is maintained regardless of whether power is being supplied to computer 1201 and/or directly to persistent storage 1213. Persistent storage 1213 may be a read only memory (ROM), but typically at least a portion of the persistent storage allows writing of data, deletion of data and re-writing of data. Some familiar forms of persistent storage include magnetic disks and solid state storage devices. Operating system 1222 may take several forms, such as various known proprietary operating systems or open-source Portable Operating System Interface type operating systems that employ a kernel. The code included in block 1245 typically includes at least some of the computer code involved in performing the inventive methods.

PERIPHERAL DEVICE SET 1214 includes the set of peripheral devices of computer 1201. Data communication connections between the peripheral devices and the other components of computer 1201 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1223 may include components such as a display screen, speaker, microphone, wearable devices (such as goggles and smart watches), keyboard, mouse, printer, touchpad, game controllers, and haptic devices. Storage 1224 is external storage, such as an external hard drive, or insertable storage, such as an SD card. Storage 1224 may be persistent and/or volatile. In some embodiments, storage 1224 may take the form of a quantum computing storage device for storing data in the form of qubits. In embodiments where computer 1201 is required to have a large amount of storage (for example, where computer 1201 locally stores and manages a large database) then this storage may be provided by peripheral storage devices designed for storing very large amounts of data, such as a storage area network (SAN) that is shared by multiple, geographically distributed computers. IoT sensor set 1225 is made up of sensors that can be used in Internet of Things applications. For example, one sensor may be a thermometer and another sensor may be a motion detector.

NETWORK MODULE 1215 is the collection of computer software, hardware, and firmware that allows computer 1201 to communicate with other computers through WAN 1202. Network module 1215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1215 are performed on the same physical hardware device. In other embodiments (for example, embodiments that utilize software-defined networking (SDN)), the control functions and the forwarding functions of network module 1215 are performed on physically separate devices, such that the control functions manage several different network hardware devices. Computer readable program instructions for performing the inventive methods can typically be downloaded to computer 1201 from an external computer or external storage device through a network adapter card or network interface included in network module 1215.

WAN 1202 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1203 is any computer system that is used and controlled by an end user (for example, a customer of an enterprise that operates computer 1201), and may take any of the forms discussed above in connection with computer 1201. EUD 1203 typically receives helpful and useful data from the operations of computer 1201. For example, in a hypothetical case where computer 1201 is designed to provide a recommendation to an end user, this recommendation would typically be communicated from network module 1215 of computer 1201 through WAN 1202 to EUD 1203. In this way, EUD 1203 can display, or otherwise present, the recommendation to an end user. In some embodiments, EUD 1203 may be a client device, such as thin client, heavy client, mainframe computer, desktop computer and so on.

REMOTE SERVER 1204 is any computer system that serves at least some data and/or functionality to computer 1201. Remote server 1204 may be controlled and used by the same entity that operates computer 1201. Remote server 1204 represents the machine(s) that collect and store helpful and useful data for use by other computers, such as computer 1201. For example, in a hypothetical case where computer 1201 is designed and programmed to provide a recommendation based on historical data, then this historical data may be provided to computer 1201 from remote database 1230 of remote server 1204.

PUBLIC CLOUD 1205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1205 is performed by the computer hardware and/or software of cloud orchestration module 1241. The computing resources provided by public cloud 1205 are typically implemented by virtual computing environments that run on various computers making up the computers of host physical machine set 1242, which is the universe of physical computers in and/or available to public cloud 1205. The virtual computing environments (VCEs) typically take the form of virtual machines from virtual machine set 1243 and/or containers from container set 1244. It is understood that these VCEs may be stored as images and may be transferred among and between the various physical machine hosts, either as images or after instantiation of the VCE. Cloud orchestration module 1241 manages the transfer and storage of images, deploys new instantiations of VCEs and manages active instantiations of VCE deployments. Gateway 1240 is the collection of computer software, hardware, and firmware that allows public cloud 1205 to communicate through WAN 1202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1206 is like public cloud 1205, except that the computing resources are only available for use by a single enterprise. While private cloud 1206 is depicted as being in communication with WAN 1202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1205 and private cloud 1206 are both part of a larger hybrid cloud.

What is claimed is:

1. A system, comprising:
a memory that stores computer executable components;
a processor that executes computer executable components stored in the memory, wherein the computer executable components comprise:
a fusion component that that models non-linear modality correlations within and across entities through Hirschfeld-Gebelein-Re'nyi maximal correlation (MaxCorr) embeddings that generates a multi-graph that preserves identities of modalities and entities; and
a multi-graph neural network (MGNN) component for task-informed reasoning in multi-graphs, that learns parameters defining the entity-modality graph connectivity and message passing in an end-to-end fashion.

2. The computer implemented system of claim 1, wherein the multi-graph neural network (MGNN) component models multi-faceted interactions between modality features.

3. The computer implemented system of claim 1, wherein the multi-graph neural network (MGNN) component models intra and inter-entity modality relationships explicitly through a entity-modality multi-graph.

4. The computer implemented system of claim 1, wherein the fusion component employs learnable Hirschfeld-Gebelein-Re'nyi (HGR) maximal correlations to express a multimodal dataset as a entity-modality multilayered graph for fusion.

5. The computer implemented system of claim 1, wherein the multi-graph neural network (MGNN) component learns task informed entity-modality multi-graph representations automatically from unstructured modality data.

6. The computer implemented system of claim 1, wherein the multi-graph neural network (MGNN) component uses walk operations to automatically mine predictive patterns from a multi-graph given targets under task-supervision and graph neural network (GNN) parameters.

7. The computer implemented system of claim 1, wherein the multi-graph neural network (MGNN) component is trained in a supervised fashion by employing only supra-node features and induced sub-graph edges. including both cross-modal and intra-planar edges, associated with entities in a training set for backpropagation.

8. The computer implemented system of claim 7, wherein during validation of the multi-layered graph neural network (MGNN) component, parameter estimates are frozen and edges corresponding to unseen entities are added to perform a forward pass for estimation.

9. A computer-implemented method, comprising:
utilizing a processor that executes computer executable components stored in memory to:
model non-linear modality correlations within and across entities through Hirschfeld-Gebelein-Re'nyi maximal correlation (MaxCorr) embeddings that generates a multi-graph that preserves the identities of the modalities and entities; and
utilizing a multi-graph neural network (MGNN) for task-informed reasoning in multi-graphs to learn parameters defining entity-modality graph connectivity and message passing in an end-to-end fashion.

10. The computer implemented of claim 9, further comprising utilizing the multi-graph neural network (MGNN) to model multi-faceted interactions between modality features.

11. The computer implemented method of claim 9, further comprising utilizing the multi-graph neural network (MGNN) to model intra and inter-entity modality relationships explicitly through a entity-modality multi-graph.

12. The computer implemented method of claim 9, further comprising employing learnable Hirschfeld-Gebelein-Re'nyi (HGR) maximal correlations to express a multimodal dataset as a entity-modality multilayered graph for fusion.

13. The computer implemented method of claim 9, further comprising the multi-graph neural network (MGNN) learning task informed entity-modality multi-graph representations automatically from unstructured modality data.

14. The computer implemented method of claim 9, further comprising the multi-graph neural network (MGNN) employing walk operations to automatically mine predictive patterns from a multi-graph given targets under task-supervision and graph neural network (GNN) parameters.

15. The computer implemented method of claim 9, further comprising training the multi-graph neural network (MGNN) in a supervised fashion by employing only supra-node features and induced sub-graph edges. including both cross-modal and intra-planar edges, associated with subjects in a training set for backpropagation.

16. The computer implemented method of claim 15, further comprising, wherein during validation of the multi-graph neural network (MGNN), parameter estimates are frozen and edges corresponding to unseen entities are added to perform a forward pass for estimation.

17. A computer program product comprising a computer readable storage medium having program instructions embodied therewith, the program instructions executable by processor to cause the processor to:
model non-linear modality correlations within and across entities through Hirschfeld-Gebelein-Re'nyi maximal correlation (MaxCorr) embeddings that generates a multi-graph that preserves the identities of the modalities and entities; and
utilize a multi-graph neural network (MGNN) for task-informed reasoning in multi-graphs to learn parameters defining entity-modality graph connectivity and message passing in an end-to-end fashion.

18. The computer program product of claim 17, wherein the program instructions are executable by the processor to cause the processor to:
utilize the multi-graph neural network (MGNN) to model multi-faceted interactions between modality features.

19. The computer program product of claim 17, wherein the program instructions are executable by the processor to cause the processor to:
employ learnable Hirschfeld-Gebelein-Re'nyi (HGR) maximal correlations to express a multimodal dataset as a entity-modality multilayered graph for fusion.

20. The computer program product of claim 17, wherein the program instructions are executable by the processor to cause the processor to:
utilize the multi-graph neural network (MGNN) to model intra and inter-entity modality relationships explicitly through a entity-modality multi-graph.
